(19) United States
(12) Patent Application Publication
(10) Pub. No.: US 2013/0154599 A1
(43) Pub. Date: Jun. 20, 2013

(54) Methods for Reducing Power Consumption of Electronic Systems

(71) Applicant: Yang Pan, Shanghai (CN)

(72) Inventor: Yang Pan, Shanghai (CN)

(21) Appl. No.: 13/329,217

(22) Filed: Dec. 16, 2011

(51) Int. Cl. G05F 3/02

(52) U.S. Cl. 323/304

(57) ABSTRACT

Evolutionary methods for reducing power consumption of an electronic system are disclosed. The electronic system comprises one or more subsystems. Each of the subsystems is connected to a supply power through a programmable power limiter that limits power delivered to the subsystem. A controller initiates a power reduction procedure by reducing power limit to reach a level that the subsystem delivers minimum acceptable performances.

### CROSS-REFERENCE TO RELATED APPLICATIONS

Not applicable

### BACKGROUND

1. Field of Invention

This invention relates to electronic devices, specifically to power management methods for electronic devices.

2. Description of Prior Art

The various embodiments described herein relate to power management of an electronic system. Various techniques are known in the art to reduce power consumption in an electronic system, particularly for devices or systems that are battery powered.

Unfortunately, however, these conventional techniques still waste significant amount of powers. There is a need to develop novel systems and methods that utilize valuable powers more efficiently.

### SUMMARY OF THE INVENTION

It is therefore an object of the present invention to provide power management methods that utilize powers more efficiently by operating electronic systems or subsystems at minimum possible power supply and yet providing satisfactory functionalities and performances.

In one embodiment, an electronic system is connected to a power supply through a power limiter that limits the maximum power that the electronic device can draw from the power supply. A controller sends a control signal to the power limiter. In response to the signal, the electronic system operates under the maximum power limit. The power limit may be determined during functional tests of the system. The power limit may be progressively adjusted down to a minimum level that the system can still deliver satisfactory functionalities and performances. Performance sensors may be used to monitor the performances of the system or the subsystem.

The inventive concept can be extended to an electronic system comprising multiple subsystems. Each of the subsystems may be connected to a power supply through a power limiter. In one aspect, a centralized controller is used. In another aspect, each of the subsystems has a controller. The electronic subsystems may be integrated in a single chip.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a diagram illustrating an exemplary system for power reduction.

FIG. 2 is a flowchart illustrating operation of the exemplary system as shown in FIG. 1.

FIGS. 3A, B and C are schematic diagrams illustrating exemplary implementations of systems for power reduction.

FIG. 4 is a flowchart illustrating operation of the exemplary system as shown in FIG. 3A.

FIG. 5 is a schematic diagram illustrating an exemplary electronic system with multiple subsystems, each of the subsystems is connected to power supply through a power limiter, and each of the subsystem has a controller.

FIG. 6 is a schematic diagram illustrating an exemplary electronic system with multiple subsystems, each of the subsystems is connected to power supply through a power limiter, and a centralized controller is used for the system.

FIG. 7 is a flowchart illustrating operation of exemplary systems as shown in FIGS. 5 and 6.

FIG. 8 is a schematic diagram illustrating one embodiment of a power limiter based upon a thermal feedback loop using pulse width modulation.

FIG. 9 is a schematic diagram illustrating another embodiment of a power limiter based upon a thermal feedback loop using bit stream modulation.

FIG. 10 is a schematic diagram illustrating another embodiment of a power limiter based upon an electrical feedback loop using bit stream modulation.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

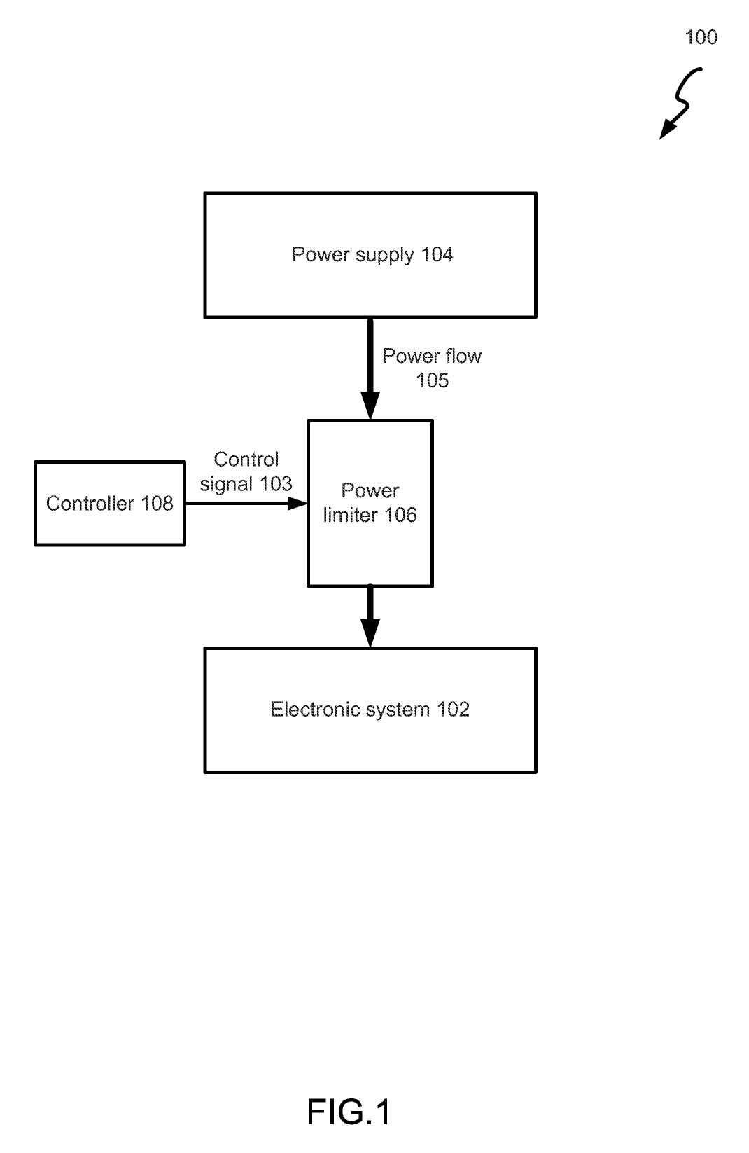

FIG. 1 illustrates an exemplary system for reducing power consumption of an electronic system. System 100 comprises an electronic system 102. Electronic system 102 may be a portable electronic device powered by a battery that includes but is not limited to a portable media player, a mobile phone, a tablet computer, a laptop computer, a game console and a digital camera. System 102 may also be an integrated circuit, such as, for example, a microprocessor or a digital signal processor. System 102 may even be a subsystem of another electronic system, such as, for example, a functional block of a System-On-Chip (SOC) type of integrated circuit. System 102 consumes electrical power and provides functionalities and performances.

System 100 further comprises a power supply 104 to provide power for electronic system 102. Power supply 104 may be a DC power supply or an AC power supply. Power supply 104 includes but is not limited to a battery including a rechargeable battery, an output from an AC/DC converter, a solar energy generation system, an outlet connected to an AC power grid and a fuel cell system. Power supply 104 may further include a power processing unit, such as, for example, a voltage regulator.

Electronic system 102 connects to power supply 104 through a power limiter 106. Power limiter 106 sets a limit for maximum power that power supply 104 can deliver to electronic system 102. Power limiter 106 is a programmable unit connected to a controller 108. In one aspect, controller 108 communicates with power limiter 106 through a wired connection (e.g., controller 108 sends control signal 103 to power limiter 106 through a databus). In another aspect, controller 108 communicates with power limiter 106 through a wireless connection. A program may be stored in a file storage system of controller 108. The program may be executed by controller 108 to reduce power consumption of electronic system 102. Controller 108 may comprise a microprocessor or microcontroller. Controller 108 may comprise special purpose processor. Controller 108 may further comprise ASIC and FPGA types of circuits. Controller 108 may comprise hardware, software and firmware.

Electrical power flow 105 flows from power supply 104 to electronic system 102 through power limiter 106 controlled by controller 108.

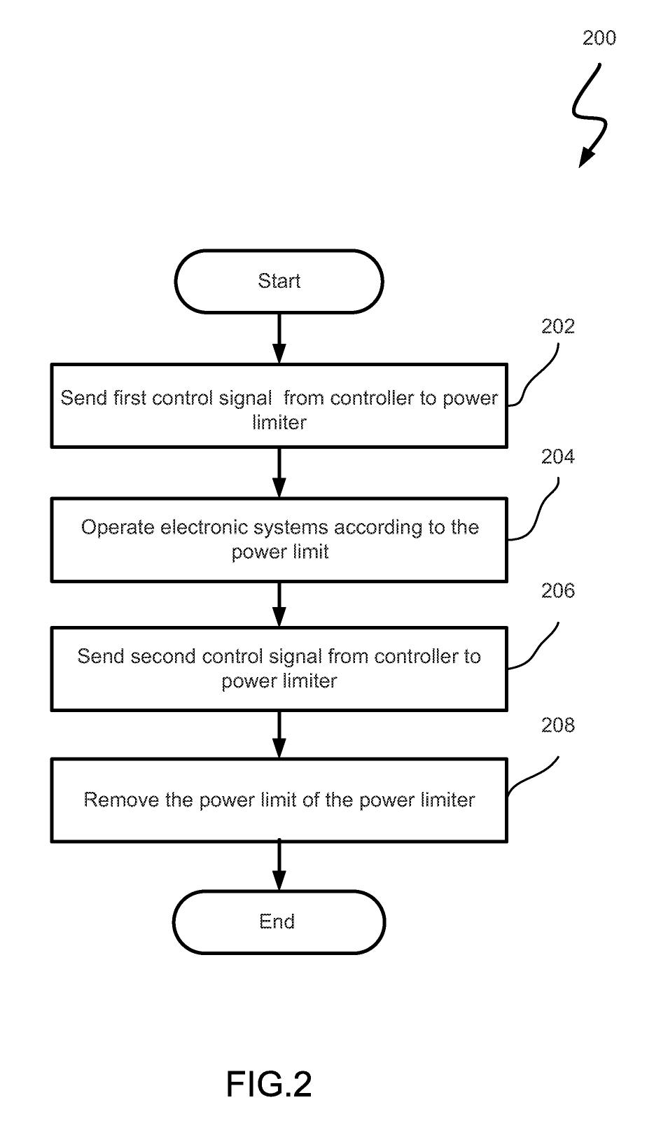

FIG. 2 is a flowchart illustrating operation of exemplary system 100. A first control signal 103 is sent from controller 108 to power limiter 106 (202). Control signal 103 comprises a signal for setting a power limit for power limiter 106. Upon receiving control signal 103, power limiter 106 activates the power limit. Therefore, electrical power 105 delivered from power supply 104 to electronic system 102 cannot exceed the power limit. Electronic system 102 is operated under the power limit (204). Controller 108 sends a second control signal 103 to power limiter 106 (206). Upon receiving the second control signal 103, the imposed power limit on power limiter 106 is removed. Electrical power 105 may flow freely from power supply 104 to electronic system 102.

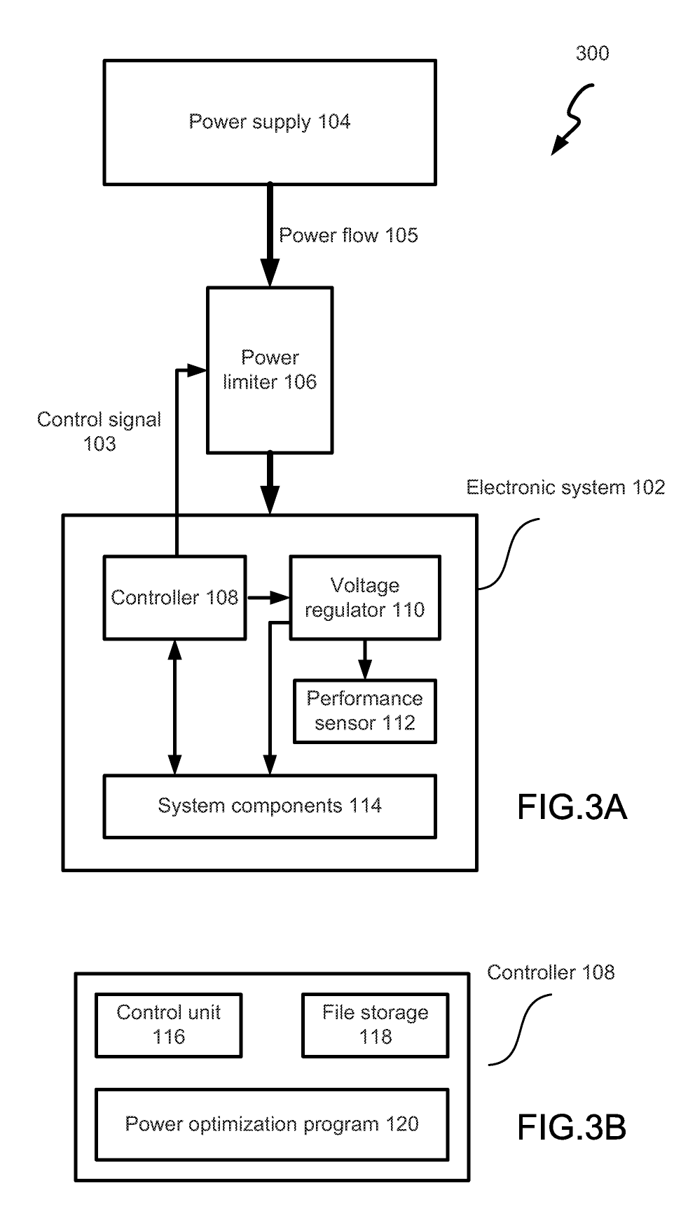

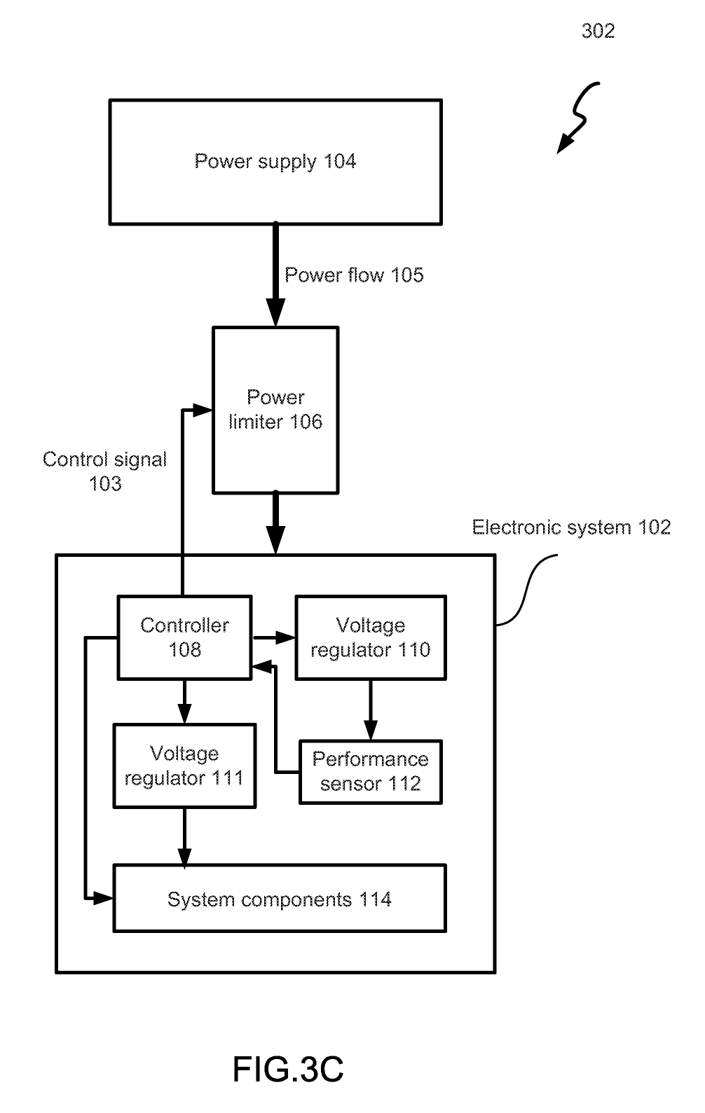

FIG. 3A is a schematic diagram illustrating an exemplary implementation of the system for power reduction (300). As shown in FIG. 3A, electronic system 102 connects to power supply 104 through power limiter 106. In the embodiment, controller 108 is a subsystem of electronic system 102. The implementation is exemplary. Controller 108 may also be a unit external to electronic system 102 in another implementation of the present embodiment. For example, controller 108 may be a part of power limiter 106 or may be an independent unit.

A voltage regulator 110 is included in electronic system 102. Voltage regulator 110 may be controlled by controller 108. When a power limit is imposed by controller 108 to power limiter 106, voltage regulator 110 generates an appropriate output voltage that is further coupled to performance sensor 112 and to system components 114. Voltage regulator 110 provides bias voltage for performance sensor 112 and system components 114. Controller 108 may include a program to find a suitable bias voltage for operations of electronic system 102. Controller 108 may control voltage regulator 110 to generate an initial output. While adjusting progressively the output of voltage regulator 110 by controller 108, performance indicators of performance sensor 112 are measured by controller 108. The program executed by controller 108 locks-in output voltage of voltage regulator 112 while the performance indicators of performance sensor 112 are optimized. Performance sensor 112 may comprise one or more test circuits and their performances are closely correlated to performances of system components 114. In an exemplary case, performance sensor 112 may have performance indicators reflecting performance of critical path in a digital integrated circuit. Performance sensor 112 may be an oscillator in one aspect. Performance sensor 112 may comprise current sensors for a NMOSFET and a PMOSFET. Measured currents depend on variations of a manufacturing process, such as for example, gate patterning and etching processes. Performance indicators of performance sensor 112 may demonstrate “look-ahead” natures. It means performance sensor 112 may fail one or more performance indicators before system components 114 actually fail.

As shown in FIG. 3B, controller 108 further comprises a control unit 116, a file storage unit 118 and a power optimization program 120. File storage 118 includes but is not limited to a flash memory and/or a cache. Power optimization program 120 is a program stored in file storage 118 that is employed to reduce power consumption of electronic system 102.

In another implementation as shown in FIG. 3C, a first voltage regulator 110 is connected to performance sensor 112 for providing its operation power and a second voltage regulator 111 is connected to system components 114 for providing its operation power. Controller 108 controls voltage regulator 111 to generate a bias voltage for system components 114. Controller 108 initiates an operation by power optimization program 120 to adjust the output of voltage regulator 110 until optimized performances of performance sensor 112 are achieved. Output voltage of regulator 110 that corresponds to the optimized performance is recorded and stored in file storage 118 of controller 108. Output of voltage regulator 111 is then adjusted to the same value to achieve optimized performances for electronic system 102. It is important that performance sensor 112 is designed to reflect performances of electronic system 102 closely. When electronic system 102 changes its operation mode, output of voltage regulators 110 and 111 will be adjusted accordingly to achieve optimized performances for the operation mode. The implementation using two voltage regulators provides freedoms for controller 108 to optimize electronic system 102 performances without disturbing its operations.

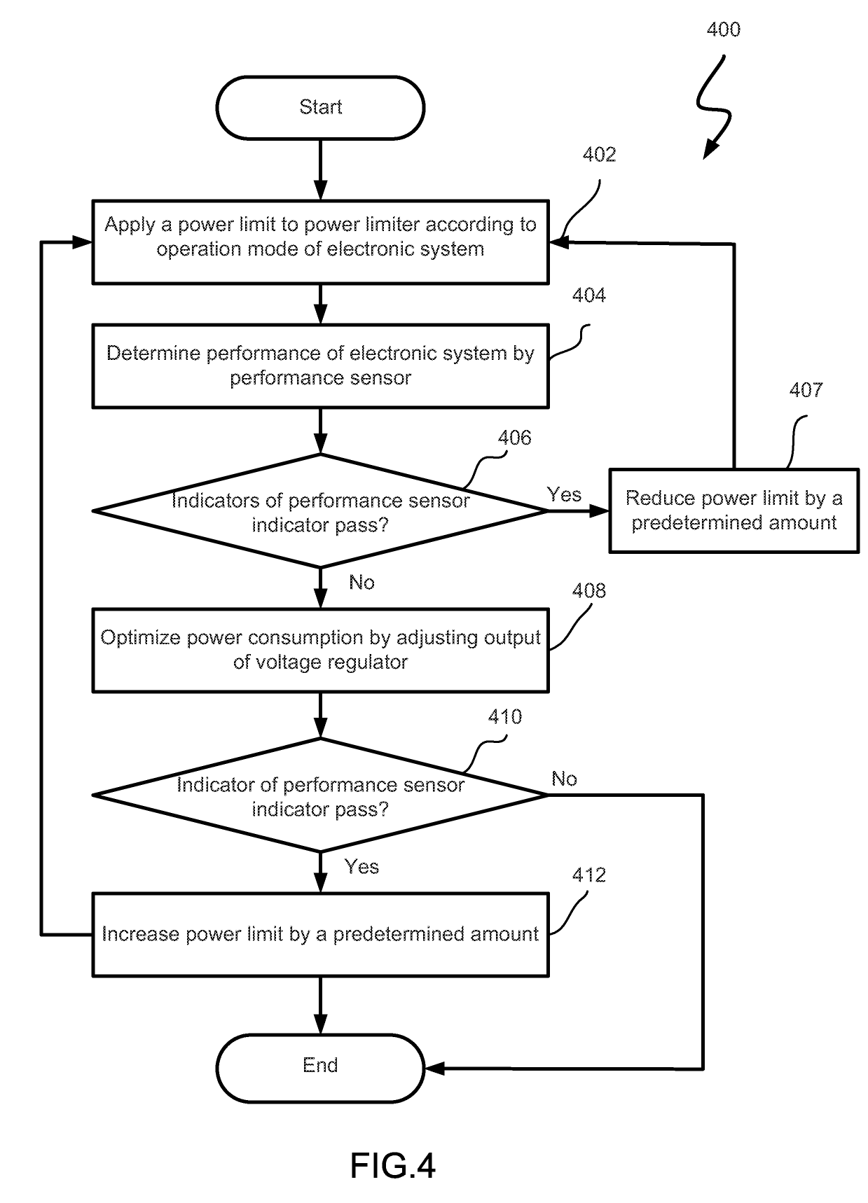

FIG. 4 is a flowchart illustrating operation of the exemplary system as shown in FIG. 3A. Process 400 starts with step 402 that a power limit is imposed to power limiter 106 by controller 108. The imposed power limit may depend on operation mode of electronic system 102. Performance indicators of performance sensor 112 are determined by controller 108 (404). The performance indicators should reflect closely performances of electronic system 102. If the determined performance indicators are above minimum acceptable levels (406), power limit imposed to power limiter 106 will be reduced by a predetermined amount (407). The performance indicators are measured accordingly. The power limit of the power limiter 106 will be reduced progressively until one or all performance indicators are below minimum acceptable levels (406). Output of voltage regulator 110 is then adjusted by controller 108 (408). Controller 108 checks if the performance indicators could be brought to above the minimum acceptable level (410). If result is positive, process 400 ends. If result is negative, the power limit of power limiter 106 is increased by a predetermined amount (412). New power limit is subsequently imposed to power limiter 106 and process of optimized power consumption is repeated.

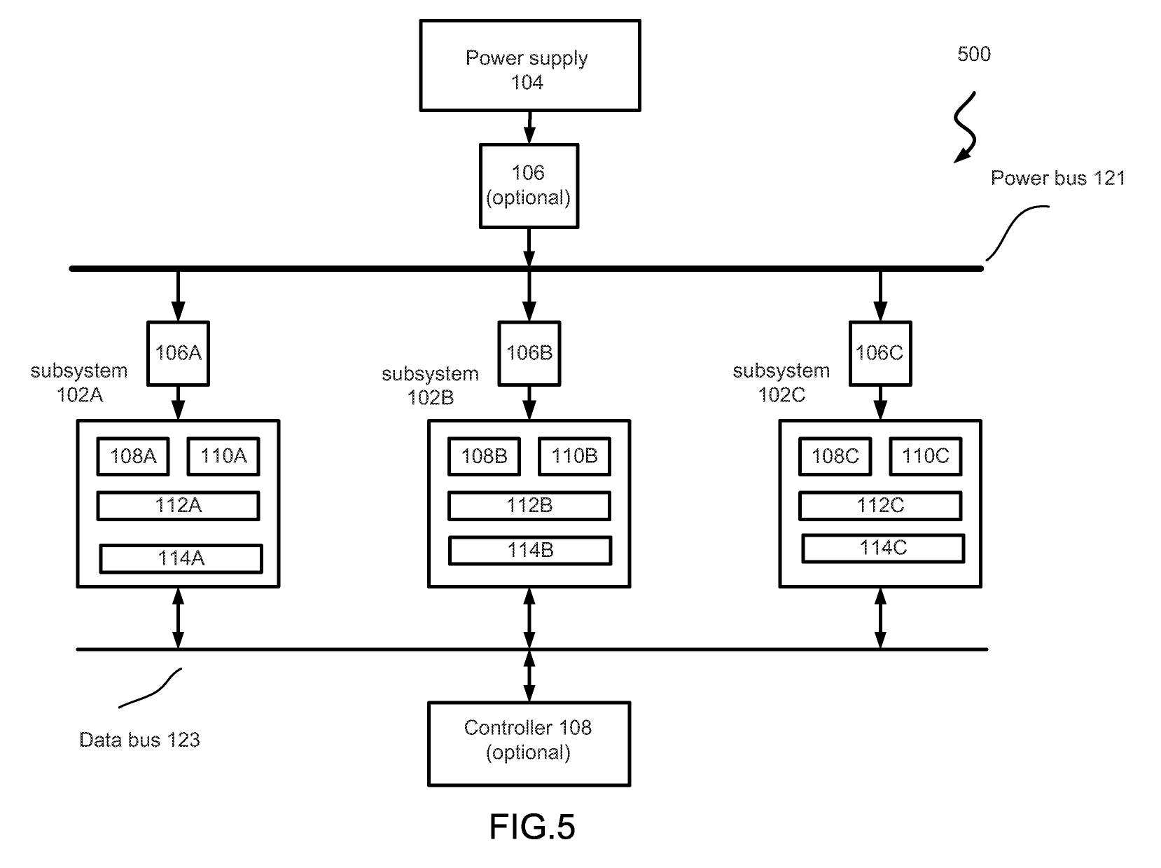

FIG. 5 is a schematic diagram illustrating an exemplary electronic system 500 including multiple subsystems 102A, 102B and 102C. Each of the subsystems is connected to power supply 104 through a power limiter (106A, 106B, or 106C) as shown in FIG. 5. Electronic system 500 may also include a centralized power limiter 106 as an option. Inclusion of power limiter 106 is exemplary and should not limit the scope of the present inventive concept. Each of subsystem may further comprise a controller, a voltage regulator, a performance sensor and system components. Electronic system 500 may further include a centralized controller 108 as an option for the purpose of illustration. Electronic system 500 may operate without the centralized controller 108. Each subsystem draws power from power supply 104 under imposed power limit by the associated power limiter. Power consumption of each of subsystems may be optimized by its controller or by centralized controller 108. Power is delivered through power bus 121. Data is transmitted through data bus 123. Three subsystems are illustrated in FIG. 5 in an exemplary manner. More or less subsystems may be included. One or more subsystems may not include a power limiter.

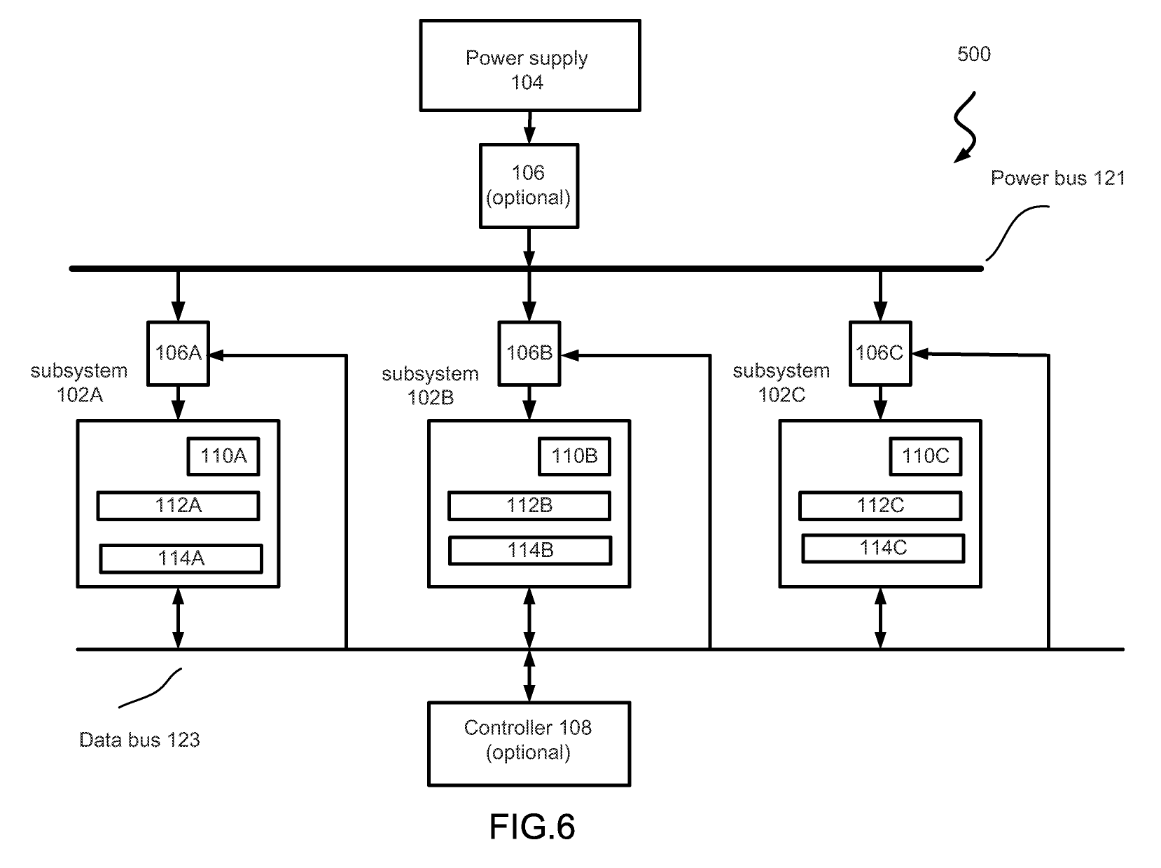

In another implementation as shown in FIG. 6, one or more subsystems may not include a controller. Centralized controller 108 is used to control power reduction in each of the subsystems. Controller 108 controls power limiters 106A-C directly.

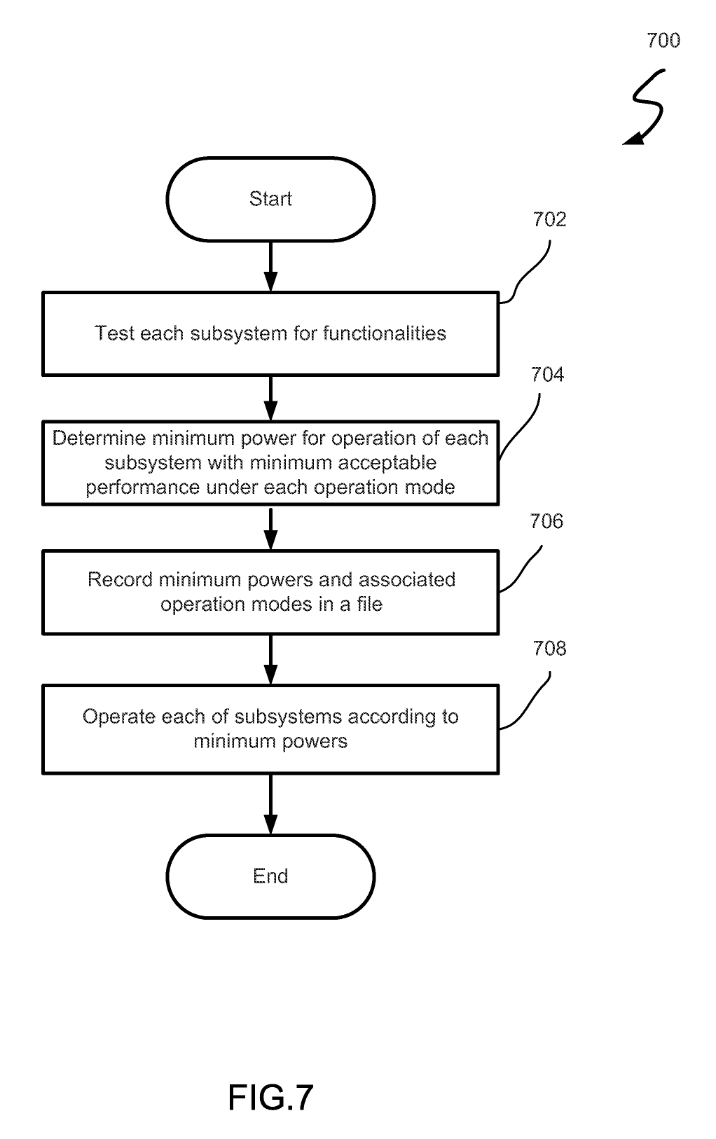

FIG. 7 is a flowchart illustrating an exemplary operation of exemplary systems as shown in FIGS. 5 and 6. Process 700 starts with step 702 that functionalities of subsystems are tested during a test event of electronic system 500. The test may be a functionality test. The test may also be a final test for a packaged system or a packaged chip. Minimum power for operating of each of the subsystems is determined for maintaining minimum acceptable performances in each of its operation mode (704). Measured minimum powers for associated operation modes are stored in file storage of controller 108 (706). Each of subsystems will be operated according to its minimum power (708). Controller 108 controls power limiters to impose power limit for each of the subsystems according to recorded minimum powers.

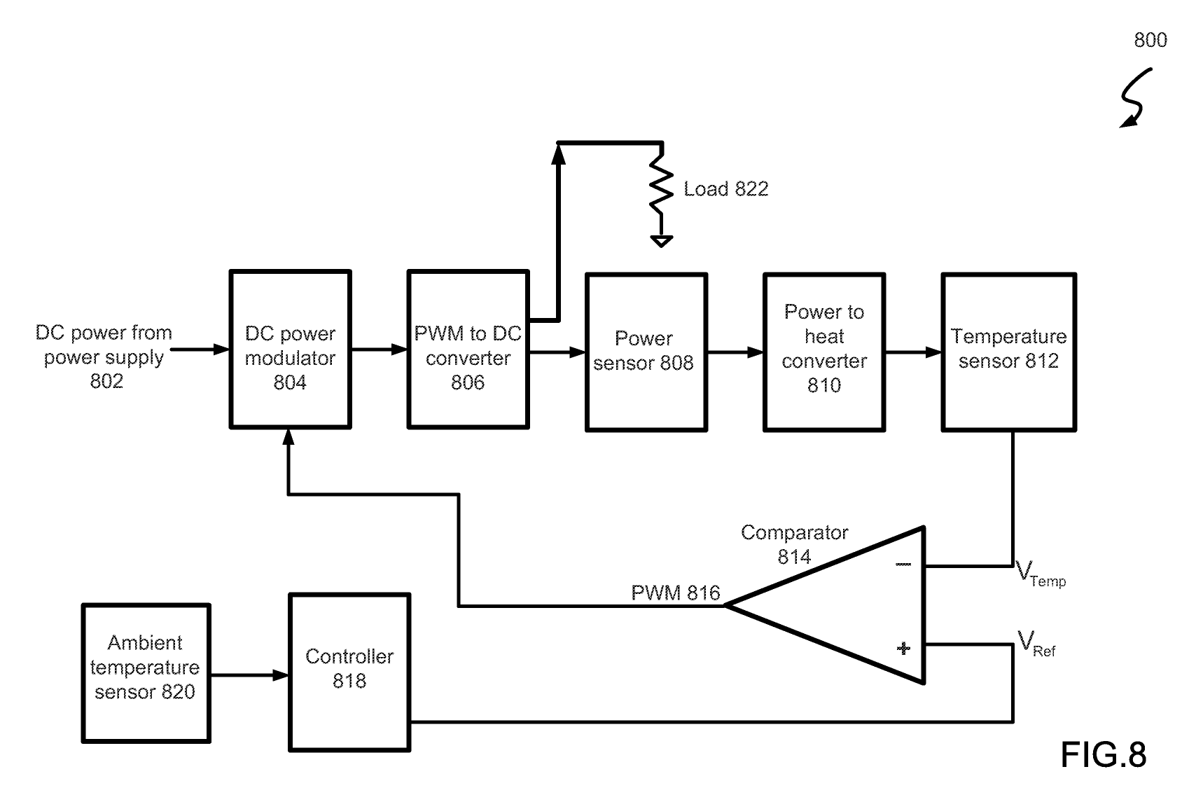

FIG. 8 shows an exemplary power limiter based upon a thermal feedback loop. Such an implementation is known from an article by Pan (the present inventor) and Huijsing in Electronic Letters 24 (1988), 542-543. This circuit is theoretically appropriate for measuring physical quantities such as speed of flow, pressure, IR-radiation, or effective value of electrical voltage or current (RMS), the influence of the quantity grated integrated circuit (chip) to its environment being determined in these cases. In these measurements, a signal conversion takes place twice: from physical (speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor.

In the embodiment, an exemplary power limiter 800 comprises an incoming DC power 802 that is drawn from power supply 104. If power supply 104 is an AC power source, an AC/DC converter may be added to convert AC power into DC power. DC power 802 is coupled to a first input of DC power modulator 804. In one aspect of the embodiment, block 804 modulates DC power 802 by a PWM signal 816. Output power of block 804, in PWM form, is converted back into DC power by PWM to DC converter 806. One of the outputs of block 806 is coupled to a power sensor 808 that receives a predetermined proportional portion of output power of block 806. Power sensor 808 may comprise a voltage sensor and a current sensor (not shown in FIG. 8). Another output of block 806 is coupled to a load 822 (electronic system 102). The output power is determined by duty cycle ratio of the PWM signal.

In another aspect of the embodiment, power sensor 808 may draw the predetermined portion of power from block 806 directly (not shown in FIG. 8). The predetermined portion of power received by DC power sensor 808 is coupled to power to heat converter (heating element) 810. Heating element 810 may be a resistor. Heating element 810 may also be an active device, such as, for example, a MOSFET or a bipolar transistor. Temperature sensor 812 measures temperature of the chip (microstructure) that includes heating element 810 and temperature sensor 812. Comparator 814 takes one input from the output of temperature sensor 812 and takes another input from a reference generated from controller 818. Controller 818 may be the same controller as 108. Controller 818 may be a different controller. The output of comparator 814 in PWM form (816) is coupled to a second input of DC power modulator 804 to modulate the incoming DC power 802 and therefore complete the thermal feedback loop. The temperature of the chip (microstructure) will oscillate around a small value set by the reference. DC power modulator 804 converts the DC power into the power in PWM form.

The maximum output power of DC power modulator 804 is determined by the reference that sets a level around which the chip's temperature will oscillate. To sustain a higher temperature, the power sensor 808 will need to draw more power proportionally from blocks 806. The reference is determined by controller 818. Controller 818 may determine the reference based upon the determined maximum power from a test result.

It should be noted that the power required to sustain the temperature level, around which the chip's temperature oscillates, also depends on an ambient temperature. At a lower ambient temperature, it requires more power to heat the heating element to maintain the temperature level. At a higher ambient temperature, less power is required. In one aspect of the embodiment, an ambient temperature sensor 820 is used to measure the ambient temperature. The measurement results are sent to controller 818. Ambient temperature may be measured regularly. Temperature sensor 820 may be a sensor external to the integrated circuit or the chip. Temperature sensor 820 may also be a part of the integrated circuit or the chip that will require an appropriate thermal isolation between temperature sensor 812 and temperature sensor 820. Such thermal isolation techniques are known in the art. Ambient temperature sensor 820 may even be integrated with controller 818.

The chip (microstructure) is associated with a thermal capacity. It requires a predetermined amount of power to heat the chip to a predetermined temperature above the ambient temperature. The required temperature difference caused by the heating power is further converted to the reference voltage by controller 818 based on characteristics of temperature sensors 812 and 820. Since power sensor 808 draws a proportional portion of power from block 806, a predetermined relationship between the output power of block 806 and the reference voltage may be established and be stored in a file storage of controller 818.

There may be various ways to integrate components of power limiter 800 at different integration levels. At a minimum level, 810 and 812 are integrated in a single chip or in a single microstructure. All such variations with different levels of integration fall within the scope of inventive concepts of the present invention.

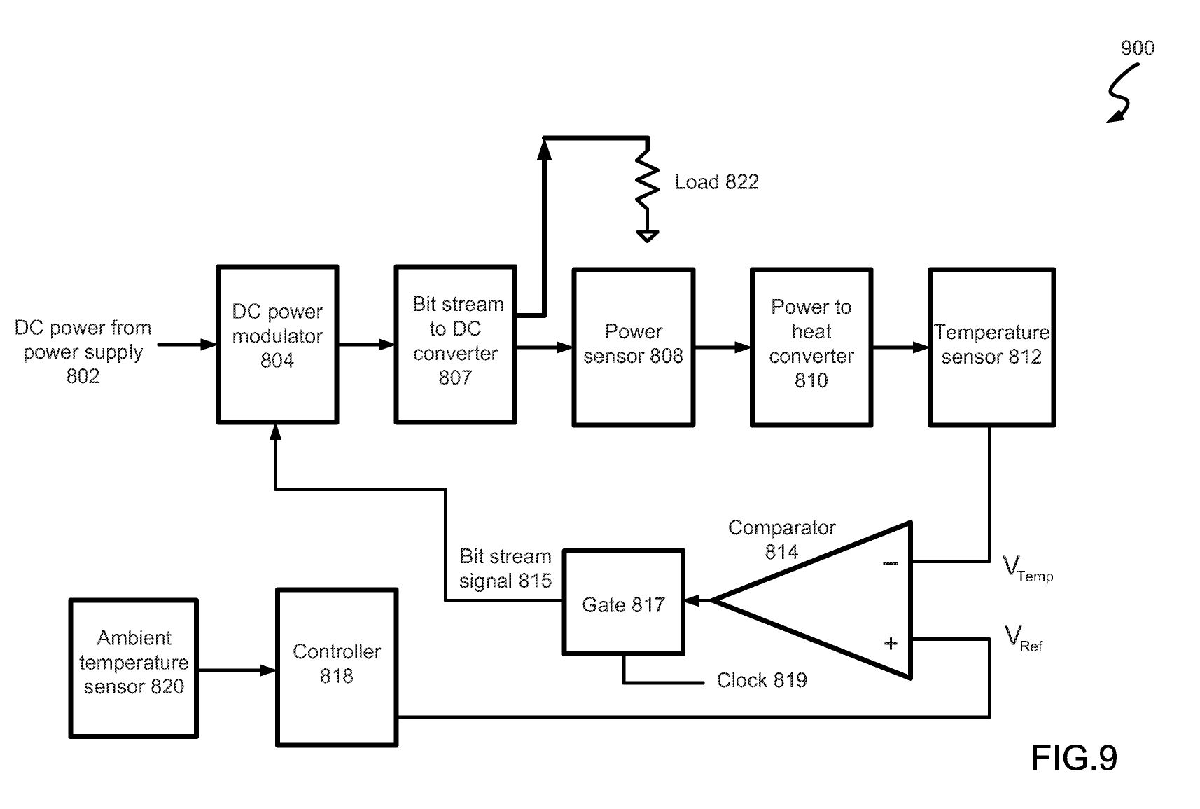

FIG. 9 illustrates an alternative embodiment of the power limiter (900). In the embodiment, the incoming DC power 802 is coupled to a first input of DC power modulator 804, wherein the incoming DC power 802 is modulated by a bit stream signal 815. An output of block 804 is coupled to bit stream to DC converter 807 to convert the power modulated by the bit stream signal back into the DC power. A predetermined proportional portion of the output power is received by power sensor 808 from one of the outputs of block 807 and is converted to heat by power to heat converter or heating element (810). DC power is delivered to load 822 (electronic system 102) through another output of block 807.

Comparator 814 takes an output of temperature sensor 812 as a first input and a reference generated by controller 818 as a second input. The output of comparator 814 is coupled to a first input of gate 817 which has a second input connected to a clock signal 819. The output (815) of gate 817 in bit stream form is coupled to the second input of DC power modulator 804. The thermal feedback loop is completed. The reference generated by controller 818 sets a level of temperature around which the chip's temperature oscillates and, therefore, sets the output power of block 804 and block 807.

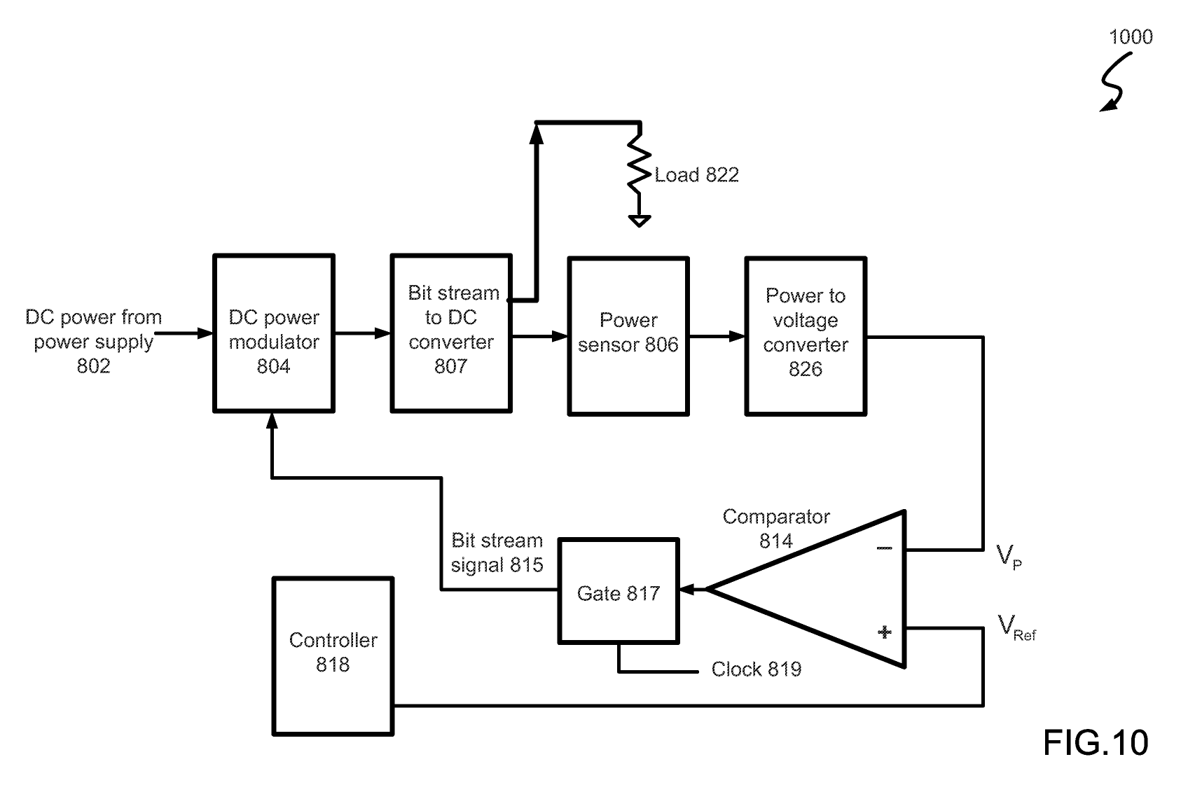

FIG. 10 illustrates yet another alternative embodiment of the power limiter (1000). In the embodiment, the incoming DC power 802 is coupled to a first input of DC power modulator 804, wherein the incoming DC power 802 is modulated by a bit stream signal 815. An output of block 804 is coupled to bit stream to DC converter 807 to convert the power modulated by the bit stream signal back into DC power. A predetermined proportional portion of the output power is received by power sensor 808 from one of the outputs of block 807 and is converted to a voltage by power to voltage converter 826. DC power from another output of block 807 is delivered to load 822 (electronic system 102).

Comparator 814 takes an output of power to voltage converter 826 as a first input and a reference generated by controller 818 as a second input. The output of comparator 814 is coupled to a first input of gate 817 which has a second input connected to a clock signal 819. The output of gate 817 in the bit stream form is coupled to the second input of DC power modulator 804. The output power of block 804 is determined by pulse counts of the bit stream signal in a predetermined time interval. The output voltage of block 826 oscillates around the reference voltage generated by controller 818. The pulse counts of the bit stream signal within a predetermined time interval determine output power of block 804 and block 807.

If several power limiters are employed based upon the thermal feedback loops, thermal isolations are required among the power limiters in order to prevent heat interferences. Therefore, power limiters based upon the thermal feedbacks are more suitable for the applications wherein subsystems are thermally isolated. Power limiters based upon the electrical feedback loop may be employed for subsystems of an integrated circuit, such as, for example, subsystems of a SOC.

While the invention has been disclosed with respect to a limited number of embodiments, numerous modifications and variations will be appreciated by those skilled in the art. Additionally, although the invention has been described particularly with respect to electronic systems with DC power supply, it should be understood that the inventive concepts disclosed herein are also generally applicable to other electronic systems with AC power supply. Furthermore, the present inventive concepts are applicable to any implementation of power limiters. It is intended that all such variations and modifications fall within the scope of the following claims:

1. A power management method for an electronic system comprising a plurality of subsystems, wherein at least one subsystem is coupled to a power supply through a power limiter, the method comprising:
(a) sending a first control signal from a controller to the power limiter, wherein said control signal comprising a signal for setting a power limit;
(b) operating the subsystem according to the power limit;
(c) sending a second control signal from the controller to the subsystem; and
(d) removing the power limit of said power limiter.

2. The method as recited in claim 1, wherein said method further comprising a means of determining an operating power for achieving predetermined minimum acceptable performances of the subsystem in each of predetermined operation modes.

3. The method as recited in claim 2, wherein said method further comprising determining said operating power by testing the subsystem during functional tests of said electronic system.

4. The method as recited in claim 3, wherein said method further comprising storing determined operating power for said predetermined operation mode in a file storage system of the controller.

5. The method as recited in claim 1, wherein said subsystem further comprising performance sensors providing means of measuring performances of said subsystem.

6. The method as recited in claim 5, wherein said performance sensors generate performance indicators that correlate to the performances of said subsystem.

7. The method as recited in claim 6, wherein said performance indicators of the performance sensors are performance predictors of said subsystem.

8. The method as recited in claim 6, wherein said performance indicators comprising indicators for speed performance of said subsystems.

9. The method as recited in claim 1, wherein said method further comprising initiating a power saving procedure by the controller for said subsystem.

10. The method as recited in claim 9, wherein said power saving procedure further comprising reducing progressively the power limit of the power limiter to a minimum level that corresponds to predetermined minimum performances of said subsystem.

11. The method as recited in claim 10, wherein said method further comprising operating said subsystem at said minimum level of power.

12. The method as recited in claim 1, wherein said power limiter is constructed based upon a thermal feedback loop.

13. The system as recited in claim 1, wherein said power limiter is constructed based upon an electrical feedback loop.

14. The method as recited in claim 1, wherein said subsystems are integrated in one or a plurality of semiconductor integrated circuits.

15. The method as recited in claim 1, wherein said method further comprising one or a plurality printed circuit boards.

16. A power management method for an electronic system comprising a plurality of subsystems, wherein at least one subsystem is coupled to a power supply through a power limiter, wherein said subsystem further comprising performance sensors, the method comprising:
(a) sending a first control signal from a controller to the power limiter, wherein said control signal comprising a signal for setting a power limit for said power limiter;
(b) operating said subsystem according to said power limit;
(c) initiating a power saving procedure by the controller, wherein said procedure further comprising establishing a new power limit that corresponds to low limits of measured performance indicators of performance sensors; and
(d) operating the subsystem according to the new power limit.

17. The method as recited in claim 16, wherein said method further comprising repeating steps (a) to (d) after said subsystem changes its operation mode.

18. The method as recited in claim 16, wherein said performance indicators of the performance sensors correlate to performances of said subsystem.

19. A power management method for an electronic system comprising a plurality of subsystems, wherein one or more subsystems are having a power limiter between the subsystems and a power supply, the method comprising:
(a) testing one or more subsystems and establishing a power limit for each of the power limiters, wherein said power limit corresponds to minimum accepted performances of the subsystem under a predetermined operation mode;
(b) storing the established power limits in a file system of the controller;
(c) sending a control signal from a controller to each of the power limiters, wherein said control signal comprising a signal for setting the power limit for the power limiter; and
(d) operating each of the subsystems according to each of the power limits.

20. The method as recited in claim 19, wherein said method further comprising establishing the power limit of said subsystem according a plurality of operation modes of said subsystem.
